(19) United States
(12) Patent Application Publication
(10) Pub. No.: US 2021/0114857 A1
(43) Pub. Date: Apr. 22, 2021

(54) VARIABLE HEIGHT FILL STATION FOR READY MIXED COMPOSITIONS

(71) Applicant: UNITED STATES GYPSUM COMPANY, Chicago, IL (US)

(72) Inventors: Brent MILLER, Sandusky, OH (US); Steven A. Harper, Port Clinton, OH (US); Roger Tarolli, Fremont, OH (US)

(21) Appl. No.: 16/657,829

(22) Filed: Oct. 18, 2019

(51) Int. Cl. B67C 3/26; B65B 1/12; B65D 88/28

(52) U.S. Cl. CPC B67C 3/26; B67C 3/282; B65D 88/28; B65B 1/12

(57) ABSTRACT

A variable height fill station for filling containers with ready mixed compositions, includes a hopper, a dispensing nozzle in fluid communication with the hopper, an inner tube having a first inner end, and an opposite second inner end, an outer tube having a first outer end telescopingly receiving the second inner end of the inner tube, and an opposite second outer end, a support frame supporting the second outer end, and providing an actuator mounting point, and a linear actuator connected at a work end to the second inner end, and at an opposite end to the support frame, so that linear reciprocation of the actuator moves the inner tube relative to the outer tube, thus adjusting an operational height of the dispensing nozzle.

### BACKGROUND

The present invention relates to automated container filling assemblies, and more specifically, to machinery used for automatically filling containers of building compositions, including ready mixed material, including but not limited to containers of wallboard joint compound.

Ready mixed, also referred to as premixed wallboard joint compound is well known in the field of interior construction for use in filling and smoothing joints or seams between adjacent wallboard panels. Typically used in conjunction with wallboard joint tape in the process of finishing the interior walls, joint compound is conventionally provided in two formats, a dry mix provided in powder form in bags that are mixed with water on the job site, and ready mixed, in which the joint compound composition is thoroughly mixed with water at the factory into a paste-like consistency, so that upon opening the container at the jobsite, the joint compound may be directly applied to the wallboard joint and/or to the joint tape. In practice, many operators opt to add water to the ready mixed formulation prior to its application to the wallboard joints.

Ready mixed joint compound is conventionally provided in 3.5 or 5 gallon pails, or 3.5 or 4.5 gallon lined cartons, collectively referred to as containers. In the manufacturing plant, these containers are filled in a designated fill line, where containers are sequentially conveyed to a fill point. At the fill point, a hopper assembly is connected to a nozzle having an internal rotating auger that dispenses a preset supply of highly viscous, paste-like, ready mixed wallboard joint compound. Preferably, the nozzle is located at a fixed height that clears a top margin or lip of any container to be filled. Such containers are filled from the nozzle to a given weight, or to a given volume, depending on the manufacturer. When different products are being formulated and packaged, compositions having different densities result in variations in the filling process, which often increases the spill rate of material.

A common disadvantage of filling the containers in this manner is that the joint compound has the tendency to “cone,” where the nozzle deposits a residue onto the level of material that temporarily projects above a desired level of the compound. As the containers move along the fill line, the material settles within the container. In some cases, the “cone” is made of a sufficient quantity of material that the level of material overflows the container and falls on the outside of the container, on the conveyor belt or on components of the conveyor line. Since the compound sets relatively rapidly, these unwanted deposits are difficult to remove once set, and if they remain on the containers, are unsightly to the consumer. Accordingly, it becomes a tedious operation to clean the containers and the conveyor line, which process as many as 10,000 containers a day. Failure to promptly clean the conveyor line results in premature failure of conveyor components.

Another related problem in automatically filling containers with ready mixed joint compound is that the various sizes of container have different heights. Thus, a specified height of the dispensing nozzle may be suitable for a first size container. Once the dispensing nozzle is fixed, it is not moved further.

To address this problem, when the operator begins filling containers for a designated product, a few test fills are performed that the level of product in the container is checked using a rigid ruler. A gross or bulk nozzle fills approximately 95% of the material, and a separate “fine” nozzle fills the remaining 5% of the desired composition at a slower rate to reach the desired total. The containers are then passed sequentially along the horizontally-moving conveyor line beneath the fixed nozzle, and each container is sequentially filled to the desired level, representing a target volume or weight.

Thus, there is a need for an improved filling apparatus for filling joint compound containers to a desired level on a production line that provides a more consistent level of material. There is also a need for an improved filling apparatus that reduces spillage and material waste.

### SUMMARY

The above-listed needs are met or exceeded by the present variable height fill station for a variety of building or construction chemical compositions, collectively referred to as ready mixed compositions, which is under operator control and provides a readily adjustable fill height for the dispensing nozzle. In the present apparatus, the dispensing nozzle, along with a hopper, a filler head, associated augers and a material feed conduit, is mounted to a powered linear actuator, which is under operator control. Before running a particular composition and filling the containers, the operator is able to automatically lower the dispensing nozzle so that it is closer to the top of the container. As such, the nozzle, along with the fill head and the respective augers are adjusted to a level that allows the material to be evenly distributed into different container sizes.

A feature of the present fill station is the electric linear actuator that raises and lowers an inner tube that is connected to the filler head. The hopper is slidably connected to an outer tube by way of a bowl mount, which is fastened to the inner tube. In the present apparatus, there is reduced contact between the outer support tube while proper auger alignment is achieved. In the preferred embodiment, the inner tube and the bowl mount are hard coat anodized with PTFE. A specialized seal box with maintenance access door keeps dust and debris away from the actuator.

In use, the present apparatus has resulted in an increase in overall production of the fill line due to a combination of more rapid adjustment of the nozzle, reduced container clean-up, as well as reduced conveyor maintenance. Also, since the product is more evenly distributed across the container, the operator can more easily verify the fill volume.

More specifically, a variable height fill station for filling containers with ready mixed compositions is provided and includes a hopper, a dispensing nozzle in fluid communication with the hopper, an inner tube having a first inner end, and an opposite second inner end, an outer tube having a first inner end telescopingly receiving the second inner end of the inner tube, and an opposite second outer end, a support frame supporting the second outer end, and providing at least one actuator mounting point, and a linear actuator connected at a work end to the second inner end, and at an opposite end to the support frame, so that linear reciprocation of the actuator moves the inner tube relative to the outer tube, thus adjusting an operational height of the dispensing nozzle.

In one embodiment, the filler head includes at least one powered auger and a material supply tube. Also, the hopper is optionally oriented for receiving joint compound from the material supply tube and being in operational range of the at least one auger. In another embodiment, the support frame includes a base plate, a plurality of support rods projecting vertically from the base plate, and an upper plate providing a mounting point for the second outer end of the outer tube.

In another embodiment, the present fill station includes a seal box mounted to the filler head for preventing the entry of joint compound between the outer tube and the inner tube. Further, the seal box preferably includes a collar secured to the outer tube, and a shield extending from the collar to an underside of the filler head.

In an embodiment, the outer tube has a vertical slot, the inner tube has at least one mounting opening in registry with the slot, and a bowl mount is provided that is attachable to the inner tube via the at least one mounting opening, so that as the inner tube is moved vertically relative to the outer tube by the linear actuator, the attachment of the bowl mount to the inner tube moves vertically simultaneously with the inner tube.

Further the bowl mount is preferably connected to the hopper, and preferably, the bowl mount is constructed and arranged for being slidable relative to the outer tube.

In an embodiment, a control interface is connected to the linear actuator for controlling linear reciprocation of the actuator and adjusting an operational height of the nozzle. Optionally, the control unit has a programmable processor configured with preset a plurality of preset nozzle heights, each nozzle height associated with a corresponding production container.

In another embodiment, a variable height fill station is provided for filling containers with ready mixed compositions, and includes a filler head, a hopper in operational relationship to the filler head, a dispensing nozzle in fluid communication with the hopper, an inner tube having a first inner end connected to the filler head, and an opposite second inner end, an outer tube having a first outer end telescopingly receiving the second inner end of the inner tube, and an opposite second outer end, a support frame supporting the second outer end, and providing an actuator mounting point, a linear actuator connected at a work end to the second inner end, and at an opposite end to the support frame, so that linear reciprocation of the actuator moves the inner tube relative to the outer tube, thus adjusting an operational height of the dispensing nozzle. A seal box is associated with the outer tube for preventing the entry of joint compound between the outer tube and the inner tube.

### BRIEF DESCRIPTION OF THE DRAWINGS

FIG. 1 is a front perspective view of the present variable height fill station showing the nozzle adjusted to a first height for filling 5-gallon pails;

FIG. 2 is a front perspective view of the present variable height fill station showing the nozzle adjusted to a second height for filling 3.5-gallon lined boxes;

FIG. 3 is a fragmentary front elevation of the present fill station linear actuator and inner and outer tube structure;

FIG. 4 is a front view of the bowl mount for securing the joint compound hoper to the tube assembly;

FIG. 5 is an overhead plan of a collar for the present seal box;

FIG. 6 is a front view of the seal box collar of FIG. 5; and

FIG. 7 is a front perspective view of a shield for the present seal box.

### DETAILED DESCRIPTION

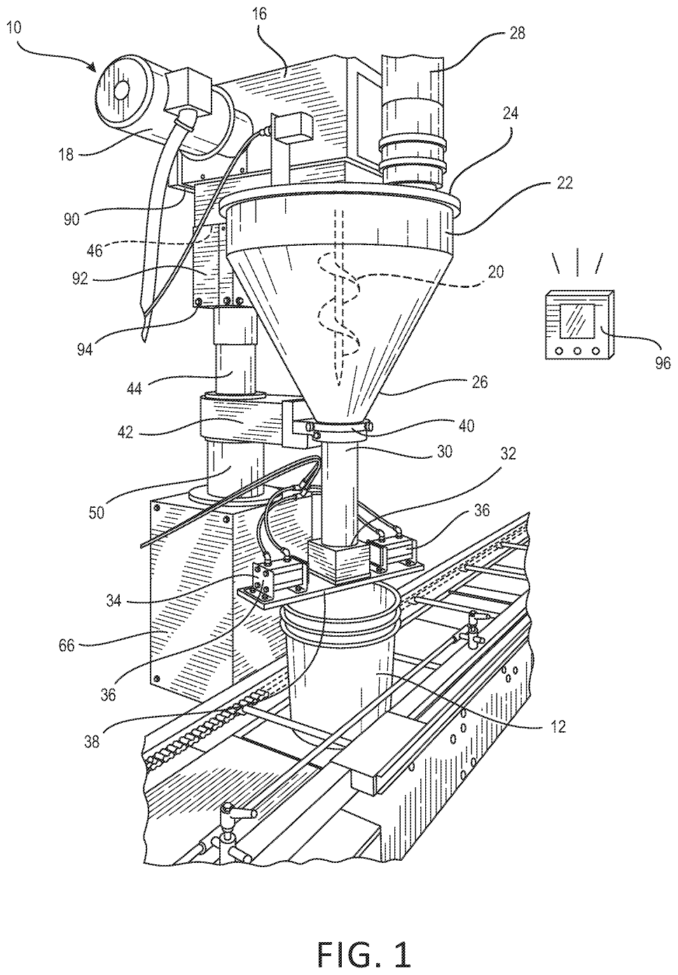

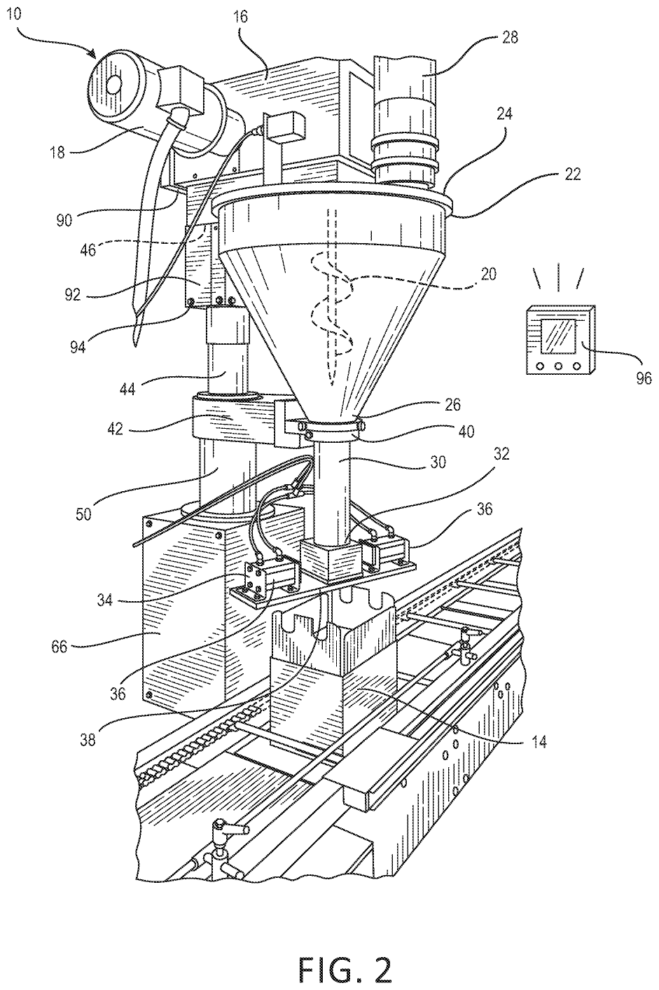

Referring now to FIGS. 1 and 2, the present variable height fill station is generally designated 10, and is constructed and arranged for being located in a facility used for filling containers with ready mixed wallboard joint compound. Conventionally, the containers generally take the form of either rigid, preferably plastic pails 12 having 3.5 or 5-gallon capacity (FIG. 1), or 3.5 or 4.5-gallon lined corrugated cardboard cartons 14 (FIG. 2). Since the containers 12, 14 have varying heights, an important feature of the present fill station 10 is the ability to rapidly adjust the filling height of the station so that the ready mixed joint compound is properly inserted into the respective container, preferably at a desired fill level and without spilling or overflow of the joint compound.

Included on the fill station 10 is a box-like filler head 16, having a motor 18 connected to at least one auger 20 (shown hidden). In many embodiments, the at least one auger 20 includes separate and coarse augers, preferably powered by drive systems (not shown). The augers 20 are in operational relation to, and depend vertically into a hopper 22 mounted to the station 10 in operational relationship to the filler head 16. Preferably, the hopper 22 is conically shaped so that it tapers or narrows from an upper open end 24 to an outlet end 26.

A material feed conduit 28 is connected to a remotely located supply of ready mixed joint compound, which is emptied into the hopper 22. The augers 20 mix the contents of the hopper 22 and push the contents toward the outlet end 26.

A preferably tubular dispensing nozzle 30 depends from, and is in fluid communication with the hopper 22 and specifically the outlet end 26. It will be understood that more than one nozzle is located at this point 30, in some cases including a fine and a bulk nozzle. The nozzle 30 receives ready mixed joint compound under pressure from the augers 20 and dispenses the compound into the desired containers, 12, 14. In the preferred embodiment, at an outlet end 32 of the dispensing nozzle 30 is located a cutoff assembly 34 including at least one laterally sliding cutoff knife (not shown). In the present embodiment, two of such knives are provided, each of which is powered by a fluid powered, preferably pneumatic actuator 36 mounted to a generally horizontally extending knife mounting plate 38. The actuators 36 are optionally under operator control, or are automatically operated based on volume or weight of dispensed joint compound.

Referring now to FIGS. 1-3, the hopper 22 is mounted via a bracket 40 to a laterally extending bowl mount 42. As will be described in greater detail below, the bowl mount 42 is attached to an inner tube 44 made of rigid material such as self-supporting steel or the like, and having an upper or first inner end 46 connected to the filler head 16, and an opposite lower or second inner end 48. In the preferred embodiment, the inner tube 44 has a constant diameter from the first inner end 46 to the second inner end 48. In the preferred embodiment, the inner tube 44 and the bowl mount 42 are hard coat anodized with PTFE. Other low friction coatings known in the art are also contemplated.

Also included on the filler station 10 is an outer tube 50 with a larger diameter than the inner tube 44 and also being made of rigid self-supporting material, similar to the inner tube 44. In addition, the outer tube 50 has a first outer end 52 telescopingly and slidingly receiving the second inner end 48 of the inner tube 44, and an opposite second outer end 54. As is the case with the inner tube 44, the outer tube 50 has a constant diameter from the first outer end 52 to the second outer end 54. In the preferred embodiment, the outer tube 50 is shorter in length than the inner tube 44. As will be described in greater detail below, the inner tube 44 slidingly reciprocates vertically relative to the outer tube 50 for adjusting the working height of the dispensing nozzle 30. Also, the outer tube 50 is provided with a vertical slot 56 preferably axially aligned with a vertical reciprocating travel path of the inner tube 44.

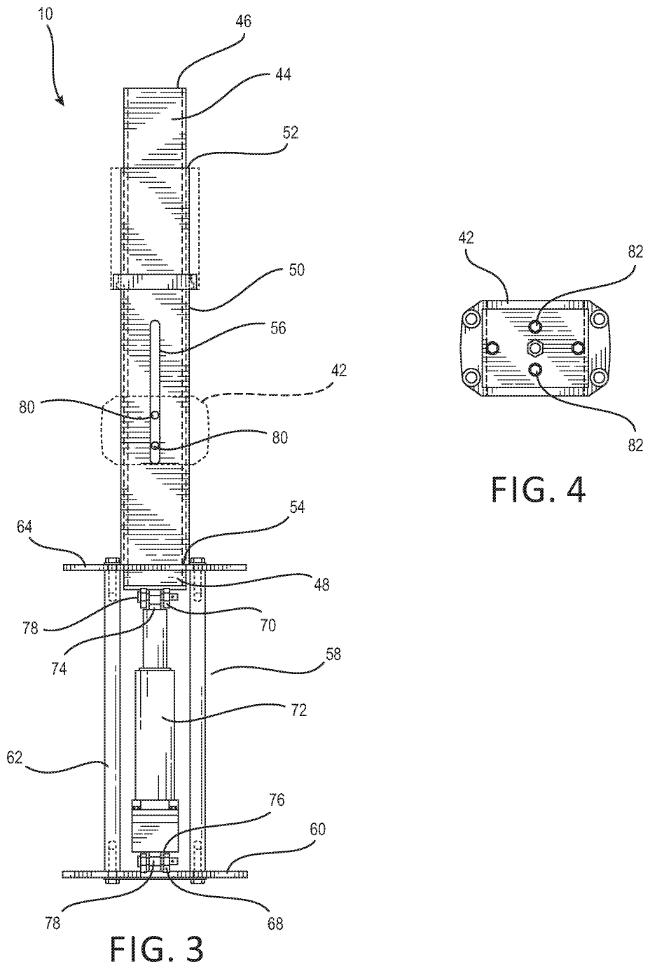

Referring now to FIG. 3, supporting the second outer end 54 is a support frame 58 located on the floor or substrate of the facility. Included on the support frame 58 is a base plate 60, a plurality of support rods 62 attached to and projecting vertically from the base plate, and an upper plate 64. The upper plate 64 is also attached to the support rods 62 and provides a mounting point for the second outer end 54 of the outer tube 50. In the preferred embodiment, the second outer end 54 is welded to the upper plate 64, however other conventionally known attachment technologies are contemplated, including threaded fasteners and appropriate brackets, or the like. Also, the support frame 58 is preferably provided with a removable enclosure 66 (FIGS. 1 and 2). It is further preferred that the base plate 60 and the second inner end 48 of the inner tube 44 each have actuator mounting points 68, 70, preferably taking the form of clevis mounts or the like, as are well known in the art.

Referring now to FIG. 3, a linear actuator 72 is inserted into the support frame 58 and is connected at a work end 74 to the second inner end 48 at the mounting point 70, and at an opposite, base end 76 to the base plate 60 of the support frame using the mounting point 68. Suitable pins or bolts 78 are used to connect the linear actuator 72 to the respective actuator mounting points 68, 70. In the preferred embodiment, the linear actuator 72 is electrically-powered, however, other power sources are contemplated, such as fluid-powered cylinders.

In operation, linear reciprocation of the linear actuator 72 moves the inner tube 44 relative to the outer tube 50, thus adjusting an operational height of the dispensing nozzle 30. Operation of the linear actuator 72 is under operator control.

Referring now to FIGS. 3 and 4, the inner tube 44 has at least one mounting opening 80 in registry with the vertical slot 56, and in the preferred embodiment there are two vertically spaced openings. Also, the bowl mount 42 is attachable to the inner tube 44 via the at least one mounting opening using pins or bolts 82. Thus, the bowl mount 42, as well as the hopper 22, once attached to the inner tube 44, is slidable relative to the outer tube 50.

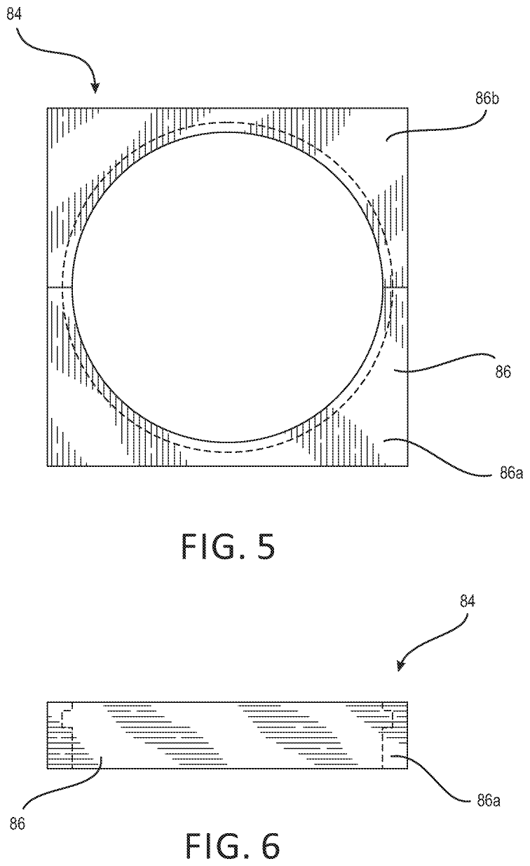

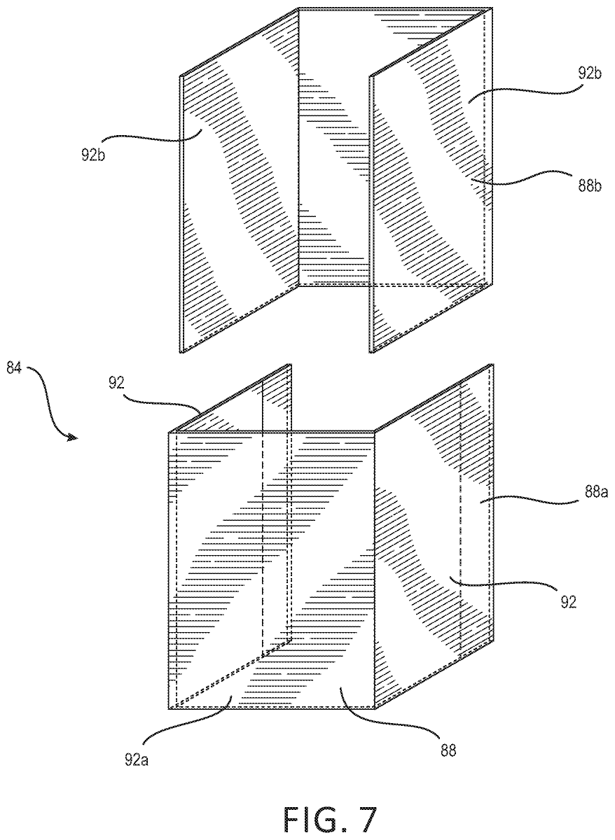

Referring now to FIGS. 3 and 5-7, another feature of the present fill station 10 is a seal box 84 mounted to the outer tube 50 for preventing the entry of joint compound between the outer tube 50 and the inner tube 44. In the preferred embodiment, the seal box 84 includes a collar 86 secured to the outer tube 50, such as by providing the collar in two complementary halves 86a, 86b, which are attached to each other about the outer tube. Also included on the seal box 84 is a shield 88 extending vertically from the collar 86 to an underside 90 of the filler head 16. In the preferred embodiment, the shield 88 includes a first portion 88a having three panels 92 formed into a “U”-shape when viewed from above. In the preferred embodiment, a central panel 92a is located opposite the hopper 22 to shield the inner tube 44 from the entry of unwanted stray or spilled joint compound particles. A second shield portion 88b is also “U”-shaped with panels 92, including two side panels 92b that slide inside complementary panels of the first portion 88a. Also, as seen in FIGS. 1 and 2, the shield 88 is secured to the collar 86 using fasteners 94, such as screws or the like.

Referring again to FIGS. 1 and 2, the fill station 10 is preferably provided with a control unit 96 connected electronically, via hard wiring or wirelessly to the linear actuator 72 and or the cutoff knife actuators 36 for selective actuation. In operation, the operator uses the control unit 96 as an interface for causing the actuator 72 to selectively raise or lower the dispensing nozzle 30 to the appropriate height for delivery of ready mixed joint compound to a selected container 12, 14. Optionally, the control unit 96 is programmed to have a plurality of preset heights which correspond to the position of the linear actuator 72 for proper delivery to a variety of containers 12, 14. The operator then selects the preset position of the dispensing nozzle 30 for the respective container 12, 14, and the linear actuator 72 then appropriately adjusts the delivery position of the nozzle as needed for effective delivery of the ready mixed joint compound.

While a particular embodiment of the present variable height fill station for ready mixed compositions has been described herein, it will be appreciated by those skilled in the art that changes and modifications may be made thereto without departing from the invention in its broader aspects and as set forth in the following claims.

What is claimed is:

1. A variable height fill station for filling containers with ready mixed compositions, comprising:
a hopper;
a dispensing nozzle in fluid communication with said hopper;
an inner tube connected having a first inner end and an opposite second inner end;
an outer tube having a first outer end telescopingly receiving said second inner end of said inner tube, and an opposite second outer end;
a support frame supporting said second outer end, and providing an actuator mounting point; and
a linear actuator connected at a work end to said second inner end, and at an opposite end to said support frame, so that linear reciprocation of said actuator moves said inner tube relative to said outer tube, thus adjusting an operational height of said dispensing nozzle.

2. The fill station of claim 1, further including a filler head located in operational relationship to said hopper, said filler head including at least one powered auger and a material supply tube.

3. The fill station of claim 2, wherein said hopper is oriented for receiving joint compound from said material supply tube and being in operational range of said at least one auger.

4. The fill station of claim 1, wherein said support frame includes a base plate, a plurality of support rods projecting vertically from said base plate, and an upper plate providing a mounting point for said second outer end of said outer tube.

5. The fill station of claim 1, further including a seal box mounted to a filler head for preventing the entry of joint compound between said outer tube and said inner tube.

6. The fill station of claim 5, wherein said seal box includes a collar secured to said outer tube, and a shield extending from said collar to an underside of said filler head.

7. The fill station of claim 1, wherein said outer tube has a vertical slot, said inner tube has at least one mounting opening in registry with said slot, and a bowl mount is provided that is attachable to said inner tube via said at least one mounting opening.

8. The fill station of claim 7, wherein said bowl mount is connected to said hopper.

9. The fill station of claim 7, wherein said bowl mount is constructed and arranged for being slidable relative to said outer tube.

10. The fill station of claim 1, further including a control interface connected to said linear actuator for controlling linear reciprocation of said actuator and adjusting an operational height of said nozzle.

11. The fill station of claim 1, wherein said control unit has a programmable processor configured with preset a plurality of preset nozzle heights, each said nozzle height associated with a corresponding production package.

12. A variable height fill station for filling containers with ready mixed compositions, comprising:
a filler head;
a hopper in operational relationship to said filler head;
a dispensing nozzle in fluid communication with said hopper;
an inner tube having a first inner end connected to said filler head, and an opposite second inner end;
an outer tube having a first outer end telescopingly receiving said second inner end of said inner tube, and an opposite second outer end;
a support frame supporting said second outer end, and providing an actuator mounting point;
a linear actuator connected at a work end to said second inner end, and at an opposite end to said support frame, so that linear reciprocation of said actuator moves said inner tube relative to said outer tube, thus adjusting an operational height of said dispensing nozzle;
a seal box associated with said outer tube for preventing the entry of joint compound between said outer tube and said inner tube.

13. The fill station of claim 12, wherein said seal box includes a collar secured to said outer tube, and a shield extending from said collar to an underside of said filler head.

14. The fill station of claim 13, wherein said shield includes three panels forming a “U”-shape when viewed from above.

15. The fill station of claim 12, wherein said filler head includes at least one powered auger and a material supply tube.

16. The fill station of claim 15, wherein said hopper is oriented for receiving joint compound from said material supply tube and being in operational range of said at least one auger.
